(19) United States
(12) Patent Application Publication
(10) Pub. No.: US 2016/0347211 A1
(43) Pub. Date: Dec. 1, 2016

(54) Laterally Collapsible Child Vehicle Seat Device

(71) Applicant: Junior Dobson, Toronto (CA)

(72) Inventor: Junior Dobson, Toronto (CA)

(21) Appl. No.: 14/721,708

(22) Filed: May 26, 2015

(51) Int. Cl. B60N 2/28; B60N 2/26

(52) U.S. Cl. CPC B60N 2/2881; B60N 2/28; B60N 2/265; B60N 2002/2896

(57) ABSTRACT

A laterally collapsible child vehicle seat device collapses laterally while unused to occupy less room within an interior of a vehicle. The device includes lateral frames having respective back portions. A first lateral side section of a back frame is pivotally coupled to the back portion of a first one of the lateral frames and a second lateral side section of the back frame is couplable to the back portion of a second one of the lateral frames such that the back frame extends between the lateral frames. A cover is coupled to and extends over the lateral frames and the back frame. The cover has a seat portion extending forwardly of the back frame and between the lateral frames. The seat portion is flexible such that the lateral frames are collapsible towards each other when the second one of the lateral frames is uncoupled from the back frame.

### BACKGROUND OF THE DISCLOSURE

### Field of the Disclosure

The disclosure relates to child vehicle seat devices and more particularly pertains to a new child vehicle seat device for collapsing laterally while unused to occupy less room within an interior of a vehicle.

### SUMMARY OF THE DISCLOSURE

An embodiment of the disclosure meets the needs presented above by generally comprising a pair of lateral frames, each of the lateral frames having a respective back portion. A back frame has opposed lateral side sections. A first one of the lateral side sections is pivotally coupled to the back portion of a first one of the lateral frames and a second one of the lateral side sections is couplable to the back portion of a second one of the lateral frames such that the back frame extends between the lateral frames. A cover is coupled to and extends over the lateral frames and the back frame. The cover has a seat portion extending forwardly of the back frame and between the lateral frames. The seat portion is flexible such that the lateral frames are collapsible towards each other when the second one of the lateral frames is uncoupled from the back frame.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side view of a laterally collapsible child vehicle seat device according to an embodiment of the disclosure.

FIG. 2 is a top front side view of an embodiment of the disclosure in a collapsed position.

FIG. 3 is a front view of an embodiment of the disclosure.

FIG. 4 is a front view of an embodiment of the disclosure in a collapsed position.

FIG. 5 is a back view of an embodiment of the disclosure.

### DESCRIPTION OF THE PREFERRED EMBODIMENT

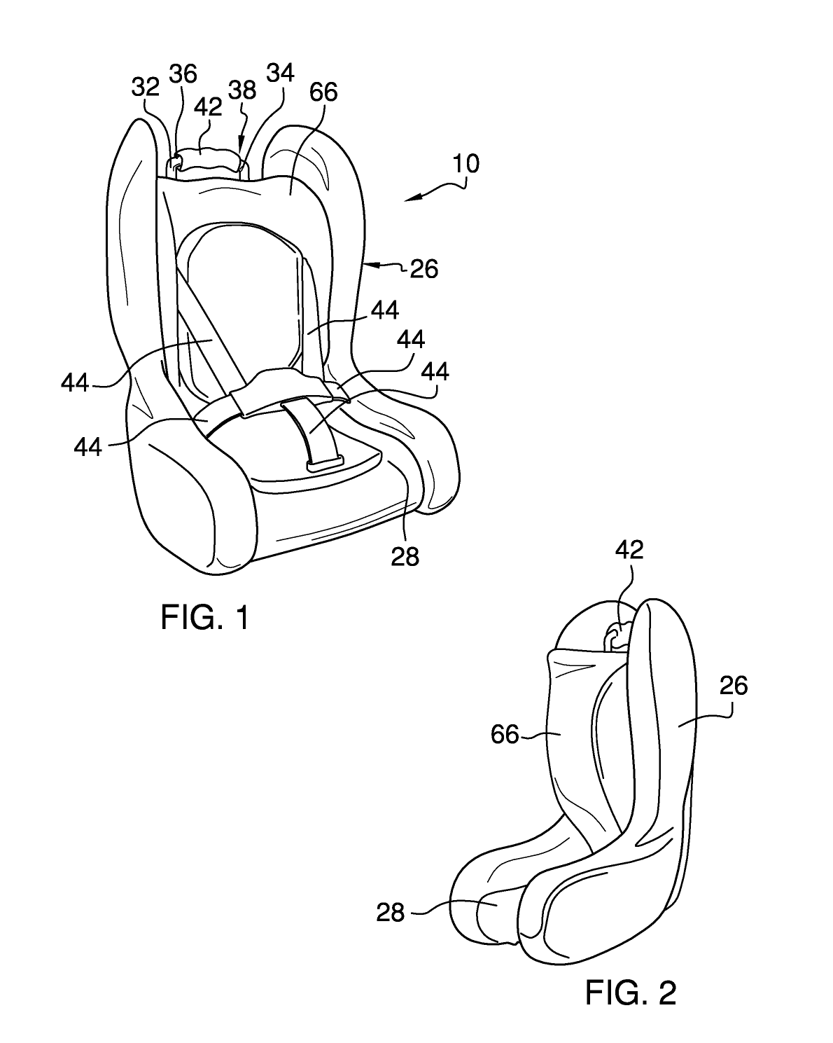

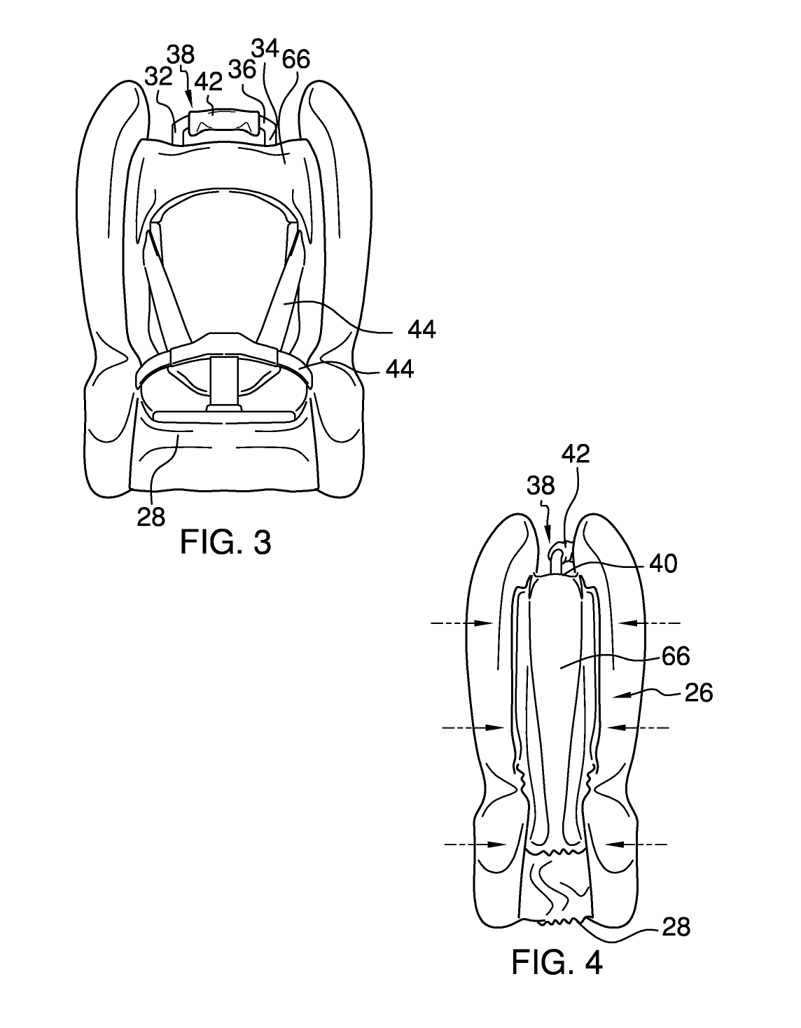

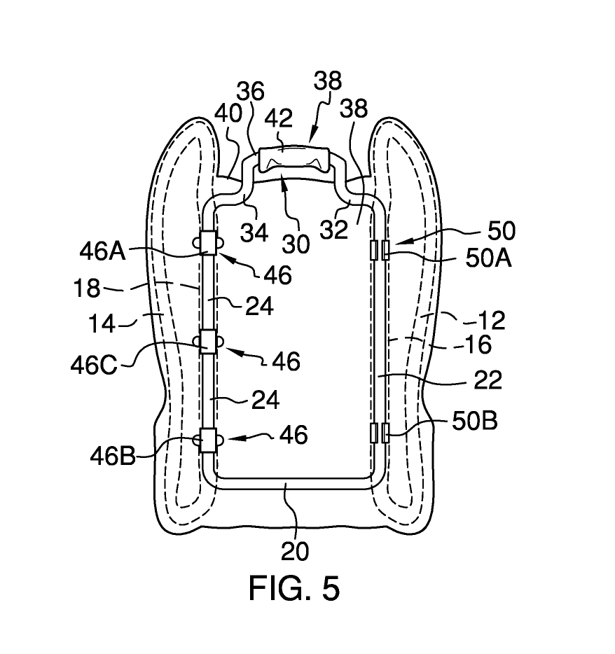

With reference now to the drawings, and in particular to FIGS. 1 through 5 thereof, a new child vehicle seat device embodying the principles and concepts of an embodiment of the disclosure and generally designated by the reference numeral 10 will be described.

As best illustrated in FIGS. 1 through 5, the laterally collapsible child vehicle seat device 10 generally comprises a pair of lateral frames 12,14. Each of the lateral frames 12,14 has a respective back portion 16,18. A back frame 20 has opposed lateral side sections 22,24. A first one of the lateral side sections 22 is pivotally coupled to the back portion 16 of a first one of the lateral frames 14. A second one of the lateral side sections 24 is couplable to the back portion 18 of a second one of the lateral frames 14 such that the back frame 20 extends between the lateral frames 12,14. A cover 26 is coupled to and extends over the lateral frames 12,14 and forwardly of the back frame 20. The cover 26 has a seat portion 28 positioned forwardly of the back frame 20 and between the lateral frames 12,14. The cover 26 further has a back portion 66 positioned forwardly of the back frame 20 and extending between the lateral frames 12,14. The seat portion 28 and back portion 66 are flexible wherein the lateral frames 12,14 are collapsible towards each other when the second one of the lateral frames 24 is uncoupled from the back frame 20. The term flexible is intended to mean the seat portion 28 and the back portion 66 allow the lateral frames 12,14 to be moved laterally towards each other collapsing the device 10. The cover 26 may further include additional padding or bracing in a conventional manner constructed to allow the cover 26 to collapse consistent with the structures of the lateral frames 12,14 and the back frame 20 as described herein.

A top portion 30 of the back frame 20 has a pair of L-shaped side sections 32,34 and a medial section 36 defining a handle 38. The medial section 36 is arcuate such that the medial section 36 is convex relative to the back frame 20. The handle 38 extends outwardly above a top edge 40 of the back portion 66 of the cover 26. A grip 42 is coupled to the handle 38.

A plurality of straps 44 is coupled to the cover 26 in a conventional configuration such that the straps 44 are configured for securing a child relative to the seat portion 28 of the cover 26. Thus, when expanded the device 10 functions as a conventional child car seat. The straps 44 may be conventionally secured relative to the back frame 20. Additional connectors of conventional design may be provided or included for coupling the device 10 into a vehicle.

Each of a plurality of hinges 46 couples the first one of the lateral frames 12 to the back frame 20. The plurality of hinges 46 includes an upper hinge 46A, a lower hinge 46B, and a medial hinge 46C. Each of a plurality of clamps 50 removably couples the second one of the lateral frames 14 to the back frame 20. The plurality of clamps 50 includes a top clamp 50A and a bottom clamp 50B.

In use, the second lateral frame 14 is uncoupled from the back frame 20 allowing the back frame 20 to be pivoted relative to the first lateral frame 12 such that the first lateral frame 12 and the back frame 20 are no longer transverse. The second lateral frame 14 may be moved laterally towards the first lateral frame 12 compacting the device 10 to occupy less space across a seat in a vehicle.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A laterally collapsible child vehicle seat device comprising:
a pair of lateral frames, each of said lateral frames having a respective back portion;
a back frame having opposed lateral side sections, a first one of said lateral side sections being pivotally coupled to said back portion of a first one of said lateral frames, a second one of said lateral side sections being couplable to said back portion of a second one of said lateral frames such that said back frame extends between said lateral frames; and
a cover coupled to and extending over said lateral frames and forwardly of said back frame, said cover having a seat portion extending forwardly of said back frame and between said lateral frames, said seat portion being flexible wherein said lateral frames are collapsible towards each other when said second one of said lateral frames is uncoupled from said back frame.

2. The device of claim 1, further comprising a top portion of said back frame having a pair of L-shaped side sections and a medial section defining a handle.

3. The device of claim 2, further comprising said medial section being arcuate such that said medial section is convex relative to said back frame.

4. The device of claim 2, further comprising said handle extending outwardly above a top edge of a back portion of said cover.

5. The device of claim 2, further comprising a grip coupled to said handle.

6. The device of claim 1, further comprising a plurality of straps coupled to said cover wherein said straps are configured for securing a child relative to said seat portion of said cover.

7. The device of claim 1, further comprising a plurality of hinges coupling said first one of said lateral frames to said back frame.

8. The device of claim 7, further comprising said plurality of hinges including an upper hinge, a lower hinge, and a medial hinge.

9. The device of claim 1, further comprising a plurality of clamps removably coupling said second one of said lateral frames to said back frame.

10. The device of claim 9, further comprising said plurality of clamps including a top clamp and a bottom clamp.

11. A laterally collapsible child vehicle seat device comprising:
a pair of lateral frames, each of said lateral frames having a respective back portion;
a back frame having opposed lateral side sections, a first one of said lateral side sections being pivotally coupled to said back portion of a first one of said lateral frames, a second one of said lateral side sections being couplable to said back portion of a second one of said lateral frames such that said back frame extends between said lateral frames; and
a cover coupled to and extending over said lateral frames and forwardly of said back frame, said cover having a seat portion extending forwardly of said back frame and between said lateral frames, said seat portion being flexible wherein said lateral frames are collapsible towards each other when said second one of said lateral frames is uncoupled from said back frame;
a top portion of said back frame having a pair of L-shaped side sections and a medial section defining a handle, said medial section being arcuate such that said medial section is convex relative to said back frame, said handle extending outwardly above a top edge of a back portion of said cover;
a grip coupled to said handle;
a plurality of straps coupled to said cover wherein said straps are configured for securing a child relative to said seat portion of said cover;
a plurality of hinges coupling said first one of said lateral frames to said back frame, said plurality of hinges including an upper hinge, a lower hinge, and a medial hinge; and
a plurality of clamps removably coupling said second one of said lateral frames to said back frame, said plurality of clamps including a top clamp and a bottom clamp.
